(19) United States
(12) Patent Application Publication
(10) Pub. No.: US 2018/0234920 A1
(43) Pub. Date: Aug. 16, 2018

(54) TERMINAL AND METHOD FOR PERFORMING DISCONTINUOUS RECEPTION MODE

(71) Applicant: ELECTRONICS AND TELECOMMUNICATIONS RESEARCH INSTITUTE, Daejeon (KR)

(72) Inventor: Hyung Deug BAE, Daejeon (KR)

(21) Appl. No.: 15/837,107

(22) Filed: Dec. 11, 2017

(30) Foreign Application Priority Data
Feb. 10, 2017 (KR) 10-2017-0018942

(51) Int. Cl. H04W 52/02; H04B 17/318

(52) U.S. Cl. CPC H04W 52/0225; H04W 76/048; H04B 17/318

(57) ABSTRACT

A method and a terminal for performing a discontinuous reception (DRX) mode include measuring reception strength of a reference signal transmitted by a base station, determining a coverage level and a length of a warming-up time using the reception strength, and starting a DRX timer determined based on the coverage level and the length of the warming-up time.

### CROSS-REFERENCE TO RELATED APPLICATION

This application claims priority to and the benefit of Korean Patent Application No. 10-2017-0018942, filed in the Korean Intellectual Property Office on Feb. 10, 2017, the entire content of which is incorporated herein by reference.

### BACKGROUND OF THE INVENTION

### 1. Field of the Invention

The present invention relates to a method and a terminal for performing a discontinuous reception (DRX) mode or an extended DRX (eDRX) mode.

### 2. Description of Related Art

When there is no data to be transmitted/received in a discontinuous reception (DRX) mode, a terminal may switch to a DRX-sleep state to reduce battery consumption. When the terminal switches to the DRX-sleep state, a base station does not transmit the data to the terminal and transmits the data to the terminal when the terminal is in a DRX-on state, that is, the terminal wakes up. The terminal operating in the DRX mode repeats the DRX-sleep state and the DRX-on state to check whether or not there is data on the paging channel, and this is called a DRX cycle. Since a time of the DRX-sleep state is also increased as the DRX cycle is increased, a battery of the terminal may be less consumed.

In a 3GPP cellular network based Internet of Things system, an extended DRX (eDRX) that the DRX cycle is extended has been introduced, and the battery consumption of the terminal is significantly reduced. For example, in a 3GPP narrowband-Internet of Things (NB-IoT), an idle mode eDRX cycle is maximally 2.91 hours.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a method and a terminal for performing a DRX mode according to a DRX timer determined by reception strength of a reference signal.

The present invention has been made in an effort to provide a method and a terminal for performing an eDRX mode according to an eDRX timer determined by reception strength of a reference signal.

An exemplary embodiment of the present invention provides a method for performing a discontinuous reception (DRX) mode by a terminal. The method for performing the DRX mode includes measuring reception strength of a reference signal transmitted by a base station, determining a coverage level and a length of a warming-up time using the reception strength, and starting a DRX timer determined based on the coverage level and the length of the warming-up time.

The determining of the coverage level and the length of the warming-up time may include receiving a reception strength threshold value for classifying the coverage level through a radio resource control (RRC) signaling, and determining the coverage level by comparing the reception strength with the reception strength threshold value.

The determining of the coverage level and the length of the warming-up time may include determining the coverage level by comparing the reception strength with a reception strength threshold value stored in the terminal; and determining a length of a warming-up time based on information about the length of the warming-up time stored in the terminal, wherein the length of the warming-up time corresponds to the determined coverage level.

A warming-up time corresponding to a low coverage level may be longer than a warming-up time corresponding to a high coverage level.

A length of the DRX timer may be a time obtained by subtracting the length of the warming-up time and the DRX-on time from a DRX cycle.

The method may further include obtaining a system frame number (SFN) synchronization by turning on a power supply of a transmitting/receiving unit after the DRX timer expires and demodulating a broadcast channel after a base station synchronization is obtained; and deriving a timing of a DRX-on sub-frame based on the SFN synchronization.

Another embodiment of the present invention provides a method for performing an extended discontinuous reception (eDRX) mode by a terminal. The method for performing the eDRX mode includes measuring reception strength of a reference signal transmitted by a base station, determining a coverage level and a length of a warming-up time using the reception strength, and starting a DRX timer determined based on the coverage level and the length of the warming-up time.

The determining of the coverage level and the length of the warming-up time may include receiving a reception strength threshold value for classifying the coverage level through a radio resource control (RRC) signaling, and determining the coverage level by comparing the reception strength with the reception strength threshold value.

The determining of the coverage level and the length of the warming-up time may include

determining the coverage level by comparing the reception strength with a reception strength threshold value stored in the terminal; and determining a length of a warming-up time based on information about the length of the warming-up time stored in the terminal, wherein the length of the warming-up time corresponds to the determined coverage level.

A warming-up time corresponding to a low coverage level may be longer than a warming-up time corresponding to a high coverage level.

A length of the eDRX timer may be a time obtained by subtracting the length of the warming-up time and the eDRX-on time from an eDRX cycle.

The method may further include obtaining a system frame number (SFN) synchronization by turning on a power supply of a transmitting/receiving unit after the eDRX timer expires and demodulating a broadcast channel after a base station synchronization is obtained, and obtaining a hyper-SFN (H-SFN) synchronization from system information (SI) obtained from a data channel; and deriving a timing of an eDRX-on sub-frame based on the H-SFN synchronization.

Yet another embodiment of the present invention provides a terminal for performing a discontinuous reception (DRX) mode. The terminal includes a processor, a memory, and a radio frequency unit, wherein the processor executes a program stored in the memory to perform operations of measuring reception strength of a reference signal transmitted by a base station; determining a coverage level and a length of a warming-up time using the reception strength; and starting a DRX timer determined based on the coverage level and the length of the warming-up time.

When the processor performs the determining of the coverage level and the length of the warming-up time, the processor may perform operations of receiving a reception strength threshold value for classifying the coverage level through a radio resource control (RRC) signaling, and determining the coverage level by comparing the reception strength with the reception strength threshold value.

When the processor performs the determining of the coverage level and the length of the warming-up time, the processor may perform operations of determining the coverage level by comparing the reception strength with a reception strength threshold value stored in the terminal; and determining a length of a warming-up time based on information about the length of the warming-up time stored in the terminal, wherein the length of the warming-up time corresponds to the determined coverage level.

A warming-up time corresponding to a low coverage level may be longer than a warming-up time corresponding to a high coverage level.

A length of the DRX timer may be a time obtained by subtracting the length of the warming-up time and the DRX-on time from a DRX cycle.

The processor may execute the program to further perform operations of obtaining a system frame number (SFN) synchronization by turning on a power supply of a transmitting/receiving unit after the DRX timer expires and demodulating a broadcast channel after a base station synchronization is obtained; and deriving a timing of a DRX-on sub-frame based on the SFN synchronization.

Yet another embodiment of the present invention provides a terminal for performing an extended discontinuous reception (eDRX) mode. The terminal includes a processor, a memory, and a radio frequency unit, wherein the processor executes a program stored in the memory to perform operations of measuring reception strength of a reference signal transmitted by a base station; determining a coverage level and a length of a warming-up time using the reception strength; and starting an eDRX timer determined based on the coverage level and the length of the warming-up time.

When the processor performs the determining of the coverage level and the length of the warming-up time, the processor may perform operations of receiving a reception strength threshold value for classifying the coverage level through a radio resource control (RRC) signaling, and determining the coverage level by comparing the reception strength with the reception strength threshold value.

When the processor performs the determining of the coverage level and the length of the warming-up time, the processor may perform operations of determining the coverage level by comparing the reception strength with a reception strength threshold value stored in the terminal; and determining a length of a warming-up time based on information about the length of the warming-up time stored in the terminal, wherein the length of the warming-up time corresponds to the determined coverage level.

A warming-up time corresponding to a low coverage level may be longer than a warming-up time corresponding to a high coverage level.

A length of the eDRX timer may be a time obtained by subtracting the length of the warming-up time and the eDRX-on time from an eDRX cycle.

The processor may execute the program to further perform operations of obtaining a system frame number (SFN) synchronization by turning on a power supply of a transmitting/receiving unit after the eDRX timer expires and demodulating a broadcast channel after a base station synchronization is obtained, and obtaining a hyper-SFN (H-SFN) synchronization from system information (SI) obtained from a data channel; and deriving a timing of an eDRX-on sub-frame based on the H-SFN synchronization.

### BRIEF DESCRIPTION OF THE DRAWINGS

FIG. 1 is a concept view illustrating a cycle and power consumption of an idle mode DRX according to an exemplary embodiment;

FIG. 2 is a concept view illustrating a paging frame and a paging occasion of the idle mode DRX according to an exemplary embodiment;

FIG. 3 is a concept view illustrating a paging hyperframe of an idle mode eDRX;

FIG. 4 is a flowchart illustrating a DRX/eDRX method according to an exemplary embodiment;

FIG. 5 is a concept view illustrating coverage levels classified by a reception strength threshold value according to an exemplary embodiment;

FIG. 6 is a view illustrating a coverage level and a warming-up time of the DRX according to an exemplary embodiment;

FIG. 7 is a view illustrating a coverage level and a warming-up time of the eDRX according to an exemplary embodiment;

FIG. 8 is a flowchart illustrating an operation of a terminal when the terminal switches from a DRX-sleep state to a DRX-on state according to an exemplary embodiment;

FIG. 9 is a flowchart illustrating an operation of a terminal when the terminal switches from an eDRX-sleep state to an eDRX-on state according to an exemplary embodiment;

FIG. 10 is a concept view comparing warming-up times and DRX timers of a terminal having a high coverage level and a terminal having a low coverage level according to an exemplary embodiment; and

FIG. 11 is a block diagram illustrating a wireless communication system according to an exemplary embodiment.

### DETAILED DESCRIPTION OF THE EMBODIMENTS

Hereinafter, exemplary embodiments of the present invention will be described in detail with reference to the accompanying drawings so that those skilled in the art may easily practice the present invention. However, the present invention may be implemented in various different ways and is not limited to the exemplary embodiments provided in the present description. In the accompanying drawings, portions unrelated to the description will be omitted in order to obviously describe the present invention, and similar reference numerals will be used to describe similar portions throughout the present specification.

Throughout the specification, a terminal may refer to a mobile station (MS), a mobile terminal (MT), an advanced mobile station (AMS), a high reliability mobile station (HR-MS), a subscriber station (SS), a portable subscriber station (PSS), an access terminal (AT), a user equipment (UE), a machine type communication (MTC) device, and the like, and may include all or some of functions of the MT, MS, AMS, HR-MS, SS, PSS, AT, UE, and the like.

In addition, a base station (BS) may represent an advanced base station (ABS), a high reliability base station (HR-BS), a node B, an evolved node B (eNodeB), an access point (AP), a radio access station (RAS), a base transceiver station (BTS), a mobile multi-hop relay (MMR)-BS, a relay station (RS) serving as the base station, a relay node (RN) serving as the base station, an advanced relay station (ARS) serving as the base station, a high reliability relay station (HR-RS) serving as the base station, a small base station [femto base station (BS), a home node B (HNB), a home eNodeB (HeNB), a pico BS, a macro BS, a micro BS, or the like], or the like, and may include all or some of the functions of the ABS, the nodeB, the eNodeB, the AP, the RAS, the BTS, the MMR-BS, the RS, the RN, the ARS, the HR-RS, the small base station, and the like.

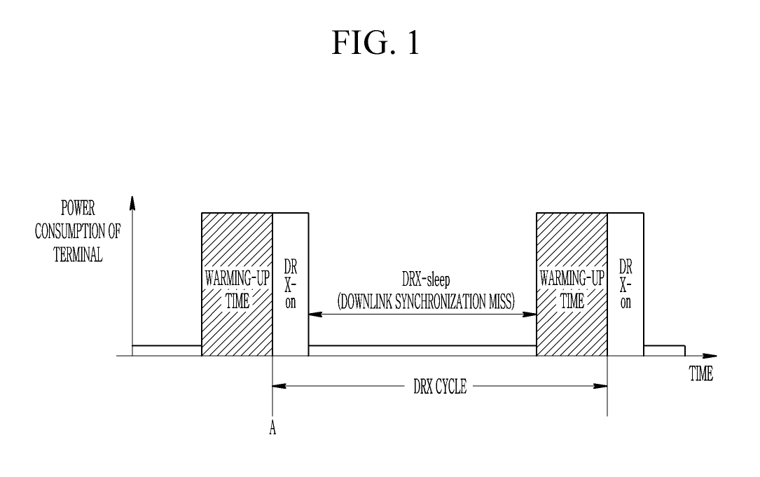

FIG. 1 is a concept view illustrating a cycle and power consumption of an idle mode DRX according to an exemplary embodiment.

When the terminal switches to a DRX-sleep state, it loses a network synchronization with a base station. Therefore, when the terminal switches from the DRX-sleep state to the DRX-on state, it takes time to acquire the network synchronization, and hereinafter, this time is called a warming-up time. Referring to FIG. 1, the terminal has the warming-up time before an active time at which the terminal switches to the DRX-on state, and in this case, the warming-up time is a time required for the terminal to switch from a no synchronize state to a synchronize state. The terminal may obtain base station synchronization and a system frame number (SFN) for the warming-up time. Thereafter, the terminal is activated during the DRX-on state and switches to the DRX-sleep state until the next warming-up time after the active time.

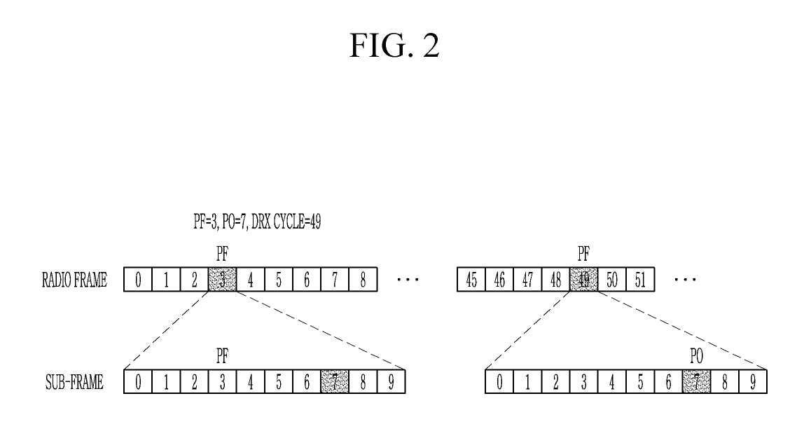

FIG. 2 is a concept view illustrating a paging frame and a paging occasion of the idle mode DRX according to an exemplary embodiment.

Referring to FIG. 2, 3GPP LTE/LTE-A, the terminal of the idle mode in DRX may know a DRX-on sub-frame through a paging frame (PF) and a paging occasion (PO). The PF denotes SFN that a paging message is transmitted and is a number between 0 and 1023. One SFN is a radio frame having a time length of 10 [ms]. The PO is a number between 0 and 9 and denotes the sub-frame having a time length of 1 [ms] included in the radio frame of the PF. The terminal may know a start sub-frame of the DRX-on calculating the PF and PO. The PP may be calculated as in Equation 1.

$$SFN mod T = \frac{T}{N} \times ( {UE}_{ID} mod N ) \qquad [ Equation 1 ]$$

In Equation 1, T is a DRX cycle and is a minimum value (min(T, nB)) of T and nB, and nB is a number of PO per the DRX cycle.

The terminal which is on the warming-up time first obtains a cell synchronization using a narrowband primary synchronization signal (NPSS) and a narrowband secondary synchronization signal (NSSS). Thereafter, the terminal obtains an SFN synchronization by reading a master information block (MIB) from a narrowband physical broadcast channel (NPBCH). In addition, the terminal calculates the PF and the PO using the cell synchronization and the SFN synchronization, finds a timing of the DRX-on sub frame, and receives a paging message transmitted during the DRX-on. If the terminal does not obtain the cell synchronization and the SFN synchronization before the timing of the DRX-on sub-frame, the terminal may not receive the paging message transmitted during the DRX-on.

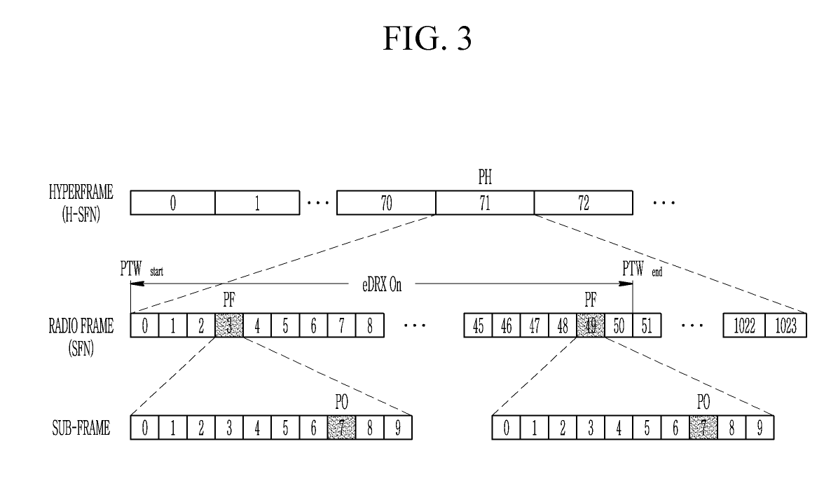

FIG. 3 is a concept view illustrating a paging hyperframe of an idle mode eDRX.

In the idle mode eDRX (i.e., NB-IoT), a hyper-system frame number (H-SFN), which is a hyperframe for extending the DRC cycle, has been introduced. Referring to FIG. 3, the H-SFN has a value between 0 and 1023 and is increased by 1 when the SFN of 10 [ms] is rounded from 0 to 1023. Therefore, a time length of one'H-SFN is 10.24 [sec]. In the eDRX, a start H-SFN at which the paging message is transmitted is defined as a paging hyperframe (PH) and is calculated as in Equation 2 below.

H−SFNmodT_{eDRX}_{ₕ}=UE_{ID}modT_{eDRX}_{ₕ} [Equation 2]

In Equation 2, T_{eDRX}_{ₕ} is an eDRX cycle and UE_{ID} is Hashed UE_ID for NB-IoT.

The terminal in the eDRX-sleep state obtains the timing of the PH and searches for timings of the PF and the PO to obtain a timing of the DRX-on. In addition, the terminal in the eDRX-sleep state completes a process of obtaining entire H -SFN information by first obtaining the cell synchronization during the warming-up time, obtaining the SFN information in NPBCH, and receiving a system information block 1 (SIB1). That is, only when the terminal in the eDRX-sleep state obtains the entire H-SFN information, the terminal may obtain the timing of the PH and receive the paging message by searching for the PF and the PO transmitted during a paging transmission window (PTVV). If the terminal does not complete the above-mentioned process before the timing of the DRX-on, the terminal may not receive the paging message transmitted during the DRX-on.

FIG. 3 illustrates a PH frame, two PTW (PTWₛₜₐᵣₜ and PTW_{end}) frames, and a PF/PO frame. In the eDRX, the PTWₛₜₐᵣₜ and the PTW_{end} indicate the SFN and the paging message is transmitted between the PTWₛₜₐᵣₜ and the PTW_{end}. In this case, a time between the PTWₛₜₐᵣₜ and the PTW_{end} is an eDRX-on section. That is, the paging message is transmitted in the eDRX-on section. Therefore, the terminal operating in the eDRX mode may receive the paging message after obtaining the timings of PH and the eDRX-on and then obtaining the timings of the PF radio frame and the PO sub-frame in the eDRX-on section. The PF and the PO may repeatedly occur during the eDRX-on section.

In a case in which the warming-up time is increased, there is a disadvantage in that battery consumption of the terminal is increased, but in a case in which the warming-up time is too short, since the timing of DRX-on or the timing of the eDRX-on occurs before the terminal in the DRX mode obtains the network synchronization and the SFN synchronization, or the terminal in the eDRX mode obtains the H-SFN synchronization, probability that the terminal does not receive the paging message is increased.

Meanwhile, in a 3GPP cellular network based Internet of Things system operating at a narrowband frequency such as NB-LTE, NB-CIoT, or NB-IoT, in order to improve received signal quality of a remote area or a deep underground area, a coverage extending technology has been introduced. Such a technology is a technology for preventing data loss and extending a coverage by repeatedly transmitting the same data N times over a plurality of sub-frames. The coverage extending technology of the 3GPP cellular network based loT system enables the data reception even in an environment in which maximum coupling loss is 165 [dB] (conventionally 144 [dB]) to improve coverage reception performance by about 20 [dB]. Here, MCL is a value denoting propagation path loss (signal loss in dB) between a transmit terminal and a receive terminal. In a case in which a propagation environment in which the IoT terminal is located is good, for example, in a case in which the MCL is smaller than 144 [dB], the IoT receiving terminal may successfully decode the data transmitted repeatedly over the plurality of sub-frames by once or only a few times. On the other hand, in a case in which the propagation environment in which the IoT terminal is located is bad, for example, in a case in which the MCL is 164 [dB] or more, the IoT terminal may successfully decode the data only after receiving and synthesizing all the data transmitted over the plurality of sub-frames. This characteristic is also applied in the same way to a case receiving a cell common channel such as the network synchronize signal (PSS/SSS) or the system broadcast information (PBCH) as well as a dedicated channel. That is, in the narrowband cellular based Internet of Things system, a reception processing time of a physical layer may be varied according to the propagation environment even in the same channel. Substantially, in accordance with a performance evaluation result of a narrowband machine-to-machine (NB-M2M) system of 3GPP TS 48.820, a network synchronization time taken to initially search for a cell is 7.2 seconds when the coupling loss is 164 [dB], while it is 0.08 seconds when the coupling loss is 144 [dB]. Further, a delay time taken to receive the system broadcast information is also similar.

As described above, in the cellular based Internet of Things system operating at the narrowband frequency, when the warming-up time for DRX/eDRX is estimated, the time required to receive the network synchronization and the broadcast information is varied according to propagation path loss of each terminal. Therefore, when the warming-up time suitable for a device having the MCL of 164 [dB] is applied to all devices, a device having the MCL of 144 [dB] unnecessarily consumes the battery due to a long warming-up time. On the contrary, when the warming-up time is applied to all devices based on the device having the MCL of 144 [dB], the devices experiencing propagation loss greater than 144 [dB] may miss the timing of the DRX-on due to a short warming-up time.

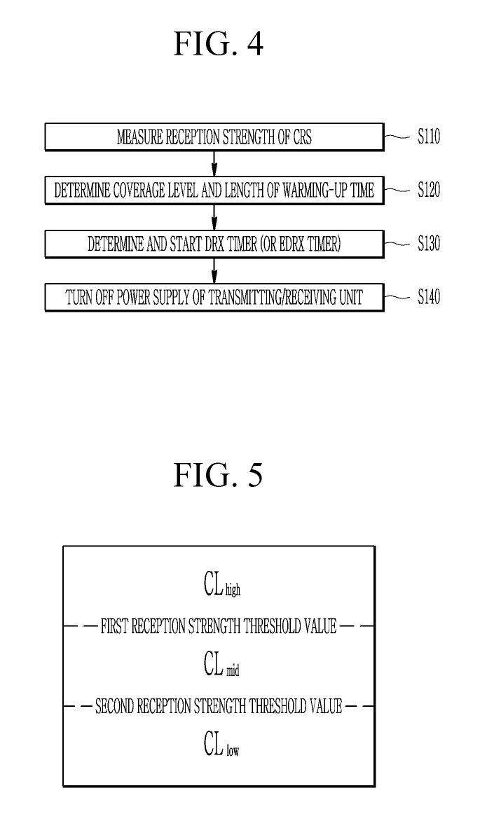

FIG. 4 is a flowchart illustrating a DRX/eDRX method according to an exemplary embodiment.

Referring to FIG. 4, the terminal first measures reception strength of a cell reference signal (CRS) broadcasted by the base station (S110). Here, the reception strength of the CRS may be reference signal received power (RSRP), reference signal received quality (RSRQ), or the like.

Thereafter, the terminal determines a coverage level (CL) and a length of the warming-up time using the reception strength of the CRS (S120). For example, the reception strength of the CRS and a predetermined reception strength threshold value (RSRP_{threshold}) are compared with each other, thereby making it possible to determine the coverage level classified by the reception strength threshold value. In other words, if the reception strength of the CRS exceeds the reception strength threshold value, the coverage level is relatively increased, and if the reception strength of the CRS is less than the predetermined reception strength threshold value, the coverage level is relatively decreased. In addition, the length of the warming-up time may be determined according to the coverage level.

According to an exemplary embodiment, the base station sets the reception strength threshold value in the terminal through a radio resource control (RRC) signaling so that the terminal may determine the coverage level. For example, when the coverage level includes three steps, two reception strength threshold values for classifying each coverage level are set in the terminal through the RRC signaling. Further, the base station may set the length of the warming-up time corresponding to each coverage level in the terminal through the RRC signaling. For example, when the coverage level includes three steps, the respective different lengths of the warming-up time corresponding to each coverage level are set in the terminal through the RRC signaling. Alternatively, the reception strength threshold value for determining the coverage level and the length of the warming-up time corresponding to each of the coverage level may be transmitted to the terminal through the system broadcast message. Alternatively, the reception strength threshold value for determining the coverage level and the length of the warming-up time corresponding to each of the coverage level are stored in the terminal.

FIG. 5 is a concept view illustrating coverage levels classified by a reception strength threshold value according to an exemplary embodiment.

Referring to FIG. 5, a first reception strength threshold value and a second reception strength threshold value according to an exemplary embodiment classify the coverage level into three steps (CL_{high}, CL_{mid}, CL_{low}). Therefore, if the reception strength of the CRS is greater than the first reception strength threshold value, the coverage level of the terminal is CL_{high}, if the reception strength of the CRS is less than the first reception strength threshold value but is greater than the second reception strength threshold value, the coverage level of the terminal is CL_{mid}, and if the reception strength of the CRS is less than the second reception strength threshold value, the coverage level of the terminal is CL_{low}.

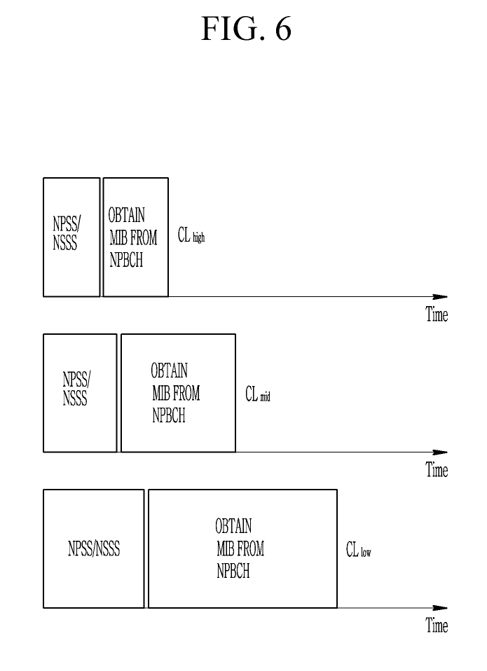

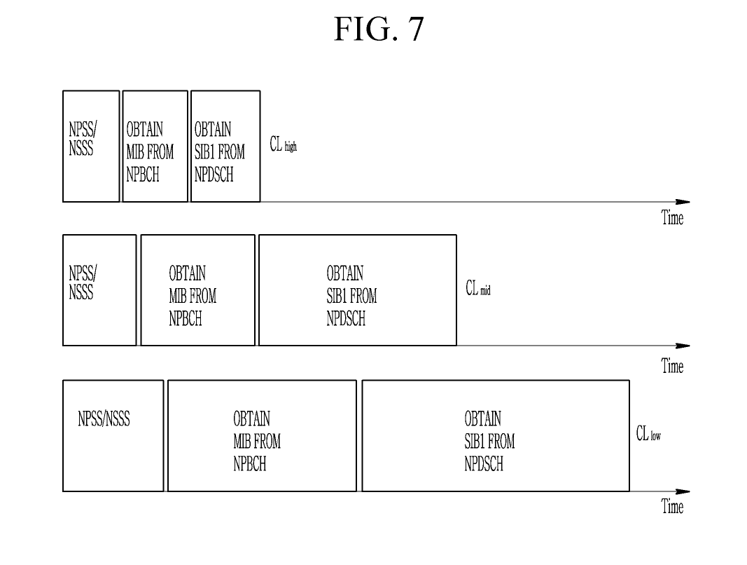

FIG. 6 is a view illustrating a coverage level and a warming-up time of the DRX according to an exemplary embodiment and FIG. 7 is a view illustrating a coverage level and a warming-up time of the eDRX according to an exemplary embodiment.

Referring to FIGS. 6 and 7, the warming-up times are set by the RRC signaling so that the warming-up time corresponding to a high coverage level (CL_{high}) is shortest than the warming-up times corresponding to the remaining coverage levels (a middle coverage level (CL_{mid}) and a low coverage level (CL_{low})) and the warming-up time corresponding to the low coverage level (CL_{low}) is longest than other coverage levels.

In FIG. 7, since the eDRX of the narrowband system such as NB-IoT requires synchronization of the superframe level, a process for receiving system information (SI) is further required, and accordingly, the warming-up time may be longer than the DRX.

Thereafter, the terminal determines a DRX timer (or an eDRX timer) value and starts a DRX timer (or an eDRX timer) (S130). Here, the DRX timer and the eDRX timer are determined by a value obtained by subtracting the warming-up time and the DRX-on time or the eDRX-on time from the DRX cycle and the eDRX cycle, and each timer starts from a DRX-on start sub-frame or an eDRX-on start sub-frame. Equations 3 and 4 below show the DRX timer and eDRX timer values.

DRX timer value=DRX cycle−DRX warming-up time−DRX-on time [Equation 3]

eDRX timer value=eDRX cycle−eDRX warming-up time−eDRX-on time (Equation 4)

Thereafter, if the DRX-on sub-frame or the eDRX-on sub-frame is terminated, the terminal turns off a power supply of a transmitting/receiving unit to enter a power save state (S140). Here, if the coverage level is changed by a movement of the terminal or the like, the terminal newly sets the warming-up time by again performing the process of FIG. 4, and resets the DRX timer and the eDRX timer accordingly.

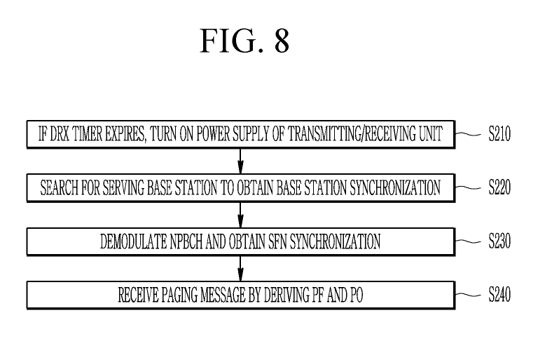

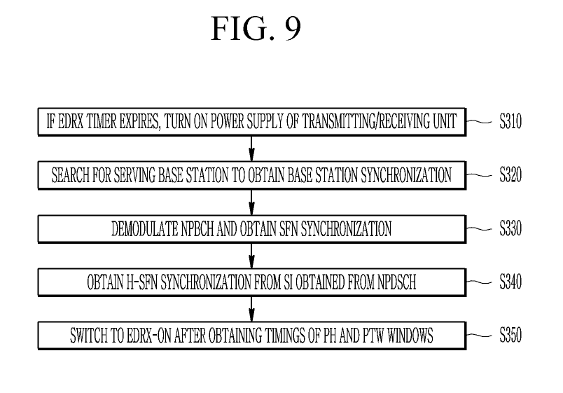

FIG. 8 is a flowchart illustrating an operation of a terminal when the terminal switches from a DRX-sleep state to a DRX-on state according to an exemplary embodiment and FIG. 9 is a flowchart illustrating an operation of a terminal when the terminal switches from an eDRX-sleep state to an eDRX-on state according to an exemplary embodiment.

Referring to FIG. 8, the terminal in the DRX-sleep state loses a downlink synchronization and an SFN synchronization because the power supply of the transmitting/receiving unit is turned off. Thereafter, if the DRX timer expires, the terminal turns on the power supply of the transmitting/receiving unit and starts a process for receiving downlink data (S210). In FIG. 4, the DRX timer value is determined such that the DRX timer expires as early as the warming-up time plus the DRX-on time from an expiration point of time of the DRX cycle according to the coverage level.

First, the terminal searches for a serving base station to obtain a base station synchronization (S220). The base station synchronization may be obtained based on NPSS/NSSS which is repeatedly transmitted. The terminal having the low coverage level may experience a longer delay in obtaining a synchronization signal such as NPSS than the terminal having the high coverage level.

The terminal obtaining the base station synchronization demodulates NPBCH and obtains the SFN synchronization (S230). A difference may occur in the time at which the terminal demodulates NPBCH according to the coverage level. Thereafter, the terminal may receive the paging message in the DRX-on state by deriving the PF and the PO according to Equation 1 (S240).

Referring to FIG. 9, the terminal in the eDRX-sleep state loses a downlink synchronization, an SFN synchronization, and a H-SFN synchronization because the power supply of the transmitting/receiving unit is turned off. Thereafter, if the eDRX timer expires, the terminal turns on the power supply of the transmitting/receiving unit and starts a process for receiving downlink data (S310). In FIG. 4, the eDRX timer value is determined such that the eDRX timer expires as early as the warming-up time plus the eDRX-on time from an expiration point of time of the eDRX cycle according to the coverage level.

First, the terminal searches for a serving base station to obtain a base station synchronization (S320). The base station synchronization may be obtained based on NPSS/NSSS which is repeatedly transmitted. The terminal having the low coverage level may experience a longer delay in obtaining a synchronization signal than the terminal having the high coverage level.

The terminal obtaining the base station synchronization demodulates NPBCH and obtains the SFN synchronization (S330). As in the case of the base station synchronization, a difference may occur in the time at which the terminal demodulates NPBCH according to the coverage level. In addition, the terminal obtains a H-SFN synchronization from the SI obtained by demodulating NPDSCH to obtain a hyperframe synchronization at which the eDRX-on state starts (S340). Thereafter, the terminal obtains timing information of PH and PTVV windows from the H-SFN synchronization and switches to the eDRX-on state (S350).

Thereafter, the terminal may receive the paging message in the eDRX-on state. That is, the terminal may drive the eDRX timer to find PF and PO sub-frame timings and receive paging information. If the eDRX-on state ends, the terminal turns off the power supply of the transmitting/receiving unit and enters the power save state. That is, the terminal switches to the eDRX-sleep state after the eDRX-on.

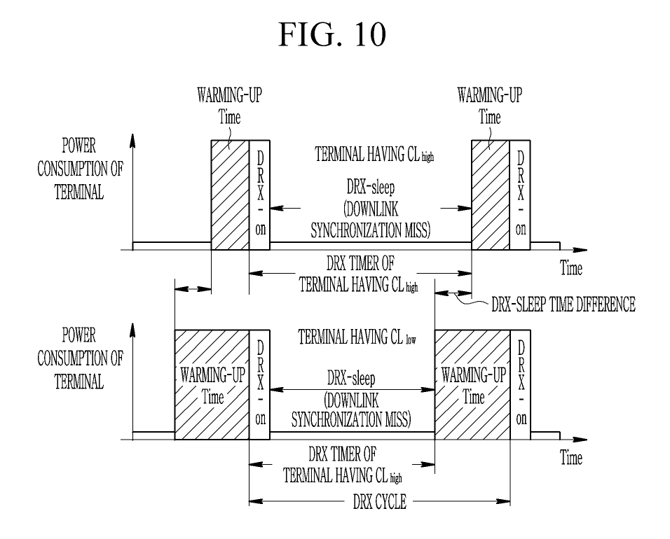

FIG. 10 is a concept view comparing warming-up times and DRX timers of a terminal having a high coverage level and a terminal having a low coverage level according to an exemplary embodiment.

The time (network synchronization delay time) required for the IoT terminal based on the narrowband cellular mobile communication system to obtain the base station synchronization, the SFN synchronization, and the H-SFN synchronization is varied according to a radio wave reception environment. According to an exemplary embodiment, since the terminal having CL_{low} has a longer network synchronization delay time than the terminal having CL_{high}, the warming-up time is determined to be relatively long according to the coverage level and the DRX (eDRX) timer is set to expire early. On the contrary, since the terminal having CL_{high} has a shorter network synchronization delay time than the terminal having CL_{low}, the warming-up time is determined to be relatively short according to the coverage level and the DRX (eDRX) timer is set to expire late.

The power supply of the terminal having CL_{low} is turned on earlier than the terminal having CL_{high}, such that the base station synchronization, the SFN synchronization, and the H-SFN synchronization are obtained. Therefore, the DRX-sleep time of the terminal having CL_{low} becomes shorter than the terminal having CL_{high}, and may not miss the paging message. On the contrary, the power supply of the terminal having CL_{high} is turned on later than the terminal having CL_{low}, such that the base station synchronization, the SFN synchronization, and the H-SFN synchronization are obtained. Therefore, since the DRX-sleep time of the terminal having CL_{high} becomes longer than the terminal having CL_{low}, power consumption may be reduced.

According to an exemplary embodiment of the present invention, the DRX timer is operated based on the coverage level determined according to the reception strength of the reference signal, thereby making it possible to secure the reception of the paging message and to reduce the power consumption of the terminal.

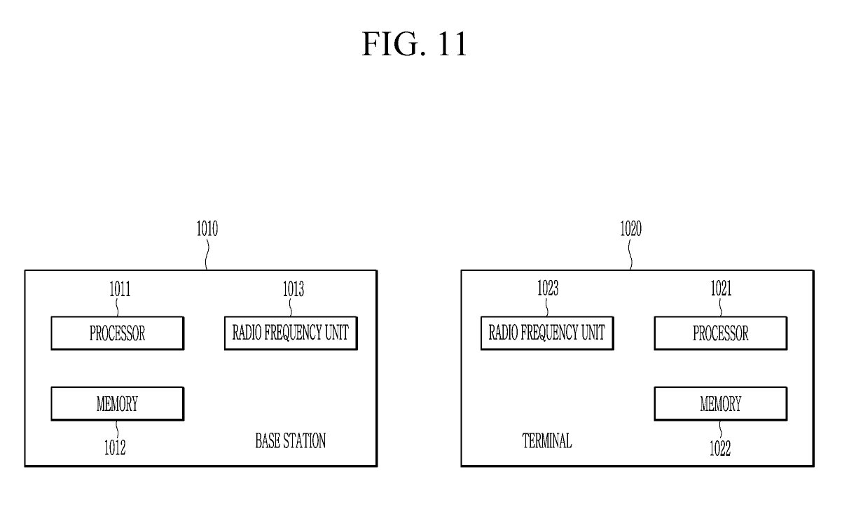

FIG. 11 is a block diagram illustrating a wireless communication system according to an exemplary embodiment.

Referring to FIG. 11, a wireless communication system according to an exemplary embodiment includes a base station 511 and a terminal 520.

The base station 1110 includes a processor 1111, a memory 1112, and a radio frequency (RF) unit (1113). The memory 1112 may be connected to the processor 1111 and may store a variety of information for driving the processor 1111 or at least one program executed by the processor 1111. The RF unit 1113 may be connected to the processor 1111, and may transmit and receive a RF signal. The processor 1111 may implement the functions, the processes, or the methods proposed by the exemplary embodiments of the present invention. Here, a wireless interface protocol layer in a wireless communication system according to an exemplary embodiment of the present invention may be implemented by the processor 1111. An operation of the base station 1110 according to an exemplary embodiment may be implemented by the processor 1111.

The terminal 1120 includes a processor 1121, a memory 1122, and a RF unit 1123. The memory 1122 may be connected to the processor 1121 and may store a variety of information for driving the processor 1121 or at least one program executed by the processor 1121. The RF unit 1123 may be connected to the processor 1121, and may transmit and receive a RF signal. The processor 1121 may implement the functions, the steps, or the methods proposed by the exemplary embodiments of the present invention. Here, a wireless interface protocol layer in a wireless communication system according to an exemplary embodiment of the present invention may be implemented by the processor 1121. An operation of the terminal 1120 according to an exemplary embodiment may be implemented by the processor 1121.

According to the exemplary embodiment of the present invention, the memory may be internal or external of the processor, and may be connected to the processor by various means which are already known. The memory is a variety of types of volatile or non-volatile storing medium. For example, the memory may include a read-only memory (ROM) or a random access memory (RAM).

While the exemplary embodiments of the present invention have been described in detail, it is to be understood that the invention is not limited to the disclosed embodiments, but on the contrary, is intended to cover various modifications and equivalent arrangements included within the spirit and scope of the appended claims.

What is claimed is:

1. A method for performing a discontinuous reception (DRX) mode by a terminal, the method comprising:
measuring reception strength of a reference signal transmitted by a base station;
determining a coverage level and a length of a warming-up time using the reception strength; and
starting a DRX timer determined based on the coverage level and the length of the warming-up time.

2. The method of claim 1, wherein the determining of the coverage level and the length of the warming-up time includes:
receiving a reception strength threshold value for classifying the coverage level through a radio resource control (RRC) signaling; and
determining the coverage level by comparing the reception strength with the reception strength threshold value.

3. The method of claim 1, wherein the determining of the coverage level and the length of the warming-up time includes:
determining the coverage level by comparing the reception strength with a reception strength threshold value stored in the terminal; and
determining a length of a warming-up time based on information about the length of the warming-up time stored in the terminal, wherein the length of the warming-up time corresponds to the determined coverage level.

4. The method of claim 3, wherein a warming-up time corresponding to a low coverage level is longer than a warming-up time corresponding to a high coverage level.

5. The method of claim 1, wherein a length of the DRX timer is a time obtained by subtracting the length of the warming-up time and the DRX-on time from a DRX cycle.

6. The method of claim 1, further comprising:
obtaining a system frame number (SFN) synchronization by turning on a power supply of a transmitting/receiving unit after the DRX timer expires and demodulating a broadcast channel after a base station synchronization is obtained; and
deriving a timing of a DRX-on sub-frame based on the SFN synchronization.

7. A method for performing an extended discontinuous reception (eDRX) mode by a terminal, the method comprising:
measuring reception strength of a reference signal transmitted by a base station;
determining a coverage level and a length of a warming-up time using the reception strength; and
starting an eDRX timer determined based on the coverage level and the length of the warming-up time.

8. The method of claim 7, wherein the determining of the coverage level and the length of the warming-up time includes:
receiving a reception strength threshold value for classifying the coverage level through a radio resource control (RRC) signaling; and
determining the coverage level by comparing the reception strength with the reception strength threshold value.

9. The method of claim 7, wherein the determining of the coverage level and the length of the warming-up time includes:
determining the coverage level by comparing the reception strength with a reception strength threshold value stored in the terminal; and
determining a length of a warming-up time based on information about the length of the warming-up time stored in the terminal, wherein the length of the warming-up time corresponds to the determined coverage level.

10. The method of claim 9, wherein a warming-up time corresponding to a low coverage level is longer than a warming-up time corresponding to a high coverage level.

11. The method of claim 7, wherein a length of the eDRX timer is a time obtained by subtracting the length of the warming-up time and the eDRX-on time from an eDRX cycle.

12. The method of claim 7, further comprising:
obtaining a system frame number (SFN) synchronization by turning on a power supply of a transmitting/receiving unit after the eDRX timer expires and demodulating a broadcast channel after a base station synchronization is obtained, and obtaining a hyper-SFN (H-SFN) synchronization from system information (SI) obtained from a data channel; and
deriving a timing of an eDRX-on sub-frame based on the H-SFN synchronization.

13. A terminal for performing an extended discontinuous reception (eDRX) mode, the terminal comprising:
a processor, a memory, and a radio frequency unit,
wherein the processor executes a program stored in the memory to perform operations of:
measuring reception strength of a reference signal transmitted by a base station;
determining a coverage level and a length of a warming-up time using the reception strength; and
starting an eDRX timer determined based on the coverage level and the length of the warming-up time.

14. The terminal of claim 13, wherein when the processor performs the determining of the coverage level and the length of the warming-up time, the processor performs operations of:
receiving a reception strength threshold value for classifying the coverage level through a radio resource control (RRC) signaling; and
determining the coverage level by comparing the reception strength with the reception strength threshold value.

15. The terminal of claim 13, wherein when the processor performs the determining of the coverage level and the length of the warming-up time, the processor performs operations of:
determining the coverage level by comparing the reception strength with a reception strength threshold value stored in the terminal; and
determining a length of a warming-up time based on information about the length of the warming-up time stored in the terminal, wherein the length of the warming-up time corresponds to the determined coverage level.

16. The terminal of claim 15, wherein a warming-up time corresponding to a low coverage level is longer than a warming-up time corresponding to a high coverage level.

17. The terminal of claim 13, wherein a length of the eDRX timer is a time obtained by subtracting the length of the warming-up time the eDRX-on time from an eDRX cycle.

18. The terminal of claim 13, wherein the processor executes the program to further perform operations of:
obtaining a system frame number (SFN) synchronization by turning on a power supply of a transmitting/receiving unit after the eDRX timer expires and demodulating a broadcast channel after a base station synchronization is obtained, and obtaining a hyper-SFN (H-SFN) synchronization from system information (SI) obtained from a data channel; and
deriving a timing of an eDRX-on sub-frame based on the H-SFN synchronization.
